(19) United States
(12) Patent Application Publication
(10) Pub. No.: US 2013/0051806 A1
(43) Pub. Date: Feb. 28, 2013

(54) Remote Controller Paring Method and System Using the Same

(71) Applicants: Michael Quilici, Essex, MA (US); Joseph A. Olsen, Gloucester, MA (US)

(72) Inventors: Michael Quilici, Essex, MA (US); Joseph A. Olsen, Gloucester, MA (US)

(73) Assignee: OSRAM SYLVANIA INC., Danvers, MA (US)

(21) Appl. No.: 13/214,724

(22) Filed: Aug. 22, 2011

(51) Int. Cl. H04B 10/00

(52) U.S. Cl. 398/106

(57) ABSTRACT

There is herein described a method for pairing a remote controller with an electronic device and a system of the remote controller and the compatible electronic device. The method includes steps of sending a directional optical signal from the remote controller to the electronic device, receiving the directional optical signal from the remote controller, detecting the signal strength of the directional optical signal, comparing the signal strength with a predetermined value, and pairing the remote controller with the electronic device when the signal strength is larger than the predetermined value.

### TECHNICAL FIELD

This invention relates to remote controllers and electronic devices compatible with remote controllers. More particularly, this invention relates to methods and systems pairing a remote controller to an electronic device.

### BACKGROUND

Remote controllers are important components of many electrical devices such as TVs, DVD players, air conditioners, home theater systems, computers, portable music players, and mobile phones. The use of remote controllers facilitates the controlling process since the user can control the device remotely. A remote controller may also be known as remote, remote control, remote switch, wireless controller, or portable remote controller. Nowadays, remote controllers may also be used to control the lighting of the house.

There exists a need for reconfigurable spaces in modern buildings. Movable partitions and drop ceilings allow for changes in the use to be facilitated by changes in the building environment. The ability to change the lighting is aided by embedding light sources into building materials such as lighted ceiling tiles and infrastructures that are based on DC ceiling grids and remote controllers. There exists the ability to move lighted ceiling tiles from one location to another and pair this lighted ceiling tile fixture to a controller by means of setting addresses or a series of button presses on the fixture and the switch. The pairing procedures are complicated by needing to get to the backside of ceiling tile fixtures. Sometimes the reconfiguration does not require the fixtures to be moved out but only requires a different pairing of fixtures and controllers.

Piezoelectric and electromagnetic energy harvesting switches are available that operate on wireless standard protocols such as EnOcean. They operate by converting the energy of the button press to electrical energy that is used to send a radio frequency (RF) signal to receivers attached to the remotely controlled devices. The methods of pairing such devices depend on proximity or a series of button presses or both. For example, US Patent Application 2010/0087217 teaches initialization methods using mesh networks to transmit information from node to node to increase the transmission distance. This process is said to be done by pressing a button on the destination node or by using a computer terminal. When the destination node is a light fixture, button pressing on the fixture side often involves a ladder, and is time consuming and requires a building maintenance personnel who knows the procedure.

Certain building control systems such as Encilium use a computer terminal with a diagram of the floor plan to do the assignment of controls. These systems are typically expensive, complicated, vulnerable to outside tampering and hacking, and require an expert user to reconfigure the lighting.

### SUMMARY OF THE INVENTION

It is an object of the invention to obviate the disadvantages of the prior art.

It is a further object of the invention to provide methods and systems for improved pairing of remote controllers with electronic devices that is easy to use and to implement.

According to an embodiment, there is provided a method for pairing a remote controller with an electronic device. The method includes steps of sending a directional optical signal from the remote controller to the electronic device, receiving the directional optical signal from the remote controller, detecting the signal strength of the directional optical signal, comparing the signal strength with a predetermined value, and pairing the remote controller with the electronic device when the signal strength is larger than the predetermined value.

According to another embodiment, there is a provided a system for pairing an electronic device with a remote controller. The system includes a remote controller and an electronic device. The remote controller includes a pairing signal source operative to send a directional optical signal. The electronic device is operative to receive the directional optical signal, detect the signal strength of the directional optical signal, compare the signal strength with a predetermined value, and pair the remote controller with the electronic device when the signal strength is larger than the predetermined value.

According to a related embodiment, the pairing signal source is operative to send the directional optical signal having a narrow beam angle. In some related embodiment, the beam angle is less than 15 degrees. In some other related embodiment, the beam angle is less than 10 degrees. In yet another related embodiment, the pairing signal source is operative to send the directional optical signal having a narrow beam angle so that the beam width or spot size of the directional optical signal on the electronic device is substantially smaller than or similar to the electronic device. In still another related embodiment, the pairing signal source is operative to send the directional optical signal having a narrow beam angle so that the spot size of the directional optical signal on the electronic device is substantially smaller than or similar to the light source.

According to yet another embodiment, there is a provided a system for pairing an electronic device with a remote controller. The system includes a remote controller and a lighting device. The remote controller includes a laser generator and radio frequency generator. The laser generator is operative to send an infrared pairing signal having a narrow beam angle. The infrared signal includes a remote controller address. The radio frequency generator is operative to send a radio frequency control signal. The radio frequency control signal includes the remote controller address. The lighting device is operative to receive the infrared pairing signal, detect the signal strength of the infrared pairing signal, compare the signal strength with a predetermined value, pair the remote controller with the electronic device when the signal strength is larger than the predetermined value, store the remote controller address to pair the remote controller, receive the radio frequency control signal, compare the remote controller address from the radio frequency control signal with one or more stored remote controller addresses from the infrared paring signal, and control the electronic device according to the radio frequency control signal if the remote controller address from the radio frequency control signal matches at least one of the stored remote controller addresses from the infrared paring signal.

For the purposes of clarity, and not by way of limitation, the systems and methods can sometimes be described herein in the context of pairing remote controllers and lighting fixtures via directional infrared signals. Once the remote controller and lighting fixture are paired, the remote controller may control the lighting fixture via omnidirectional RF signals. However, it will be understood that the systems and methods of the present invention can be applied to any other suitable type of remote controllers and electronic devices compatible with such remote controllers. In the cases of LED lighting fixtures, the LEDs can be used as sensor as well as light sources, which is cost effective by using the same component for multiple functions.

### BRIEF DESCRIPTION OF THE DRAWINGS

FIG. 1 is shows an illustrative diagram of a system in accordance with one embodiment of the invention.

FIG. 2 is flowchart of an illustrative process for pairing a remote controller with an electronic device in accordance with one embodiment of the invention.

### DETAILED DESCRIPTION

For a better understanding of the present invention, together with other and further objects, advantages and capabilities thereof, reference is made to the following disclosure and appended claims taken in conjunction with the above-described drawings.

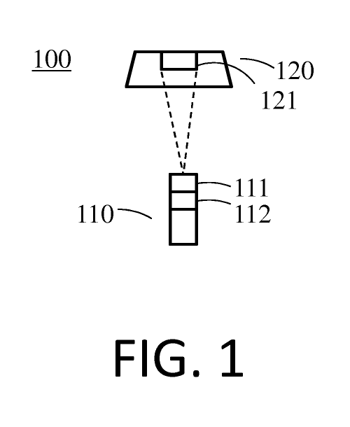

With reference to FIG. 1, a system 100 for pairing an electronic device 120 with a remote controller 110, in accordance with an embodiment of the invention is shown. The electronic device 120 is preferred to be, but not limited to, a lighting device. The lighting device 120 may include a light source 121. The light source 121 may include, but not limited to, at least one light emitting diode (LED). The remote controller 110 includes a pairing signal source 111 and control signal source 112. The pairing signal source 111 may be a directional light source operative to send a directional optical signal. The pairing signal source 111 may include an LED, a collimated LED, or a laser. The directional optical signal may be an infrared (IR) light, a visible light, or an ultraviolet (UV) light. The pairing signal source 111 is operative to send the directional optical signal with a narrow beam angle, preferably less than 15 degrees, more preferably less than 10 degrees. In some embodiments, the beam angle is narrow so that the spot size of the directional optical signal on the lighting device is substantially smaller than or similar to the electronic device, preferably substantially smaller than the light source. Thus, once the directional optical signal reaches the lighting device 120, the lighting device 120 is singled out for the intention of pairing. The pairing signal source 111 may be powered by a battery or energy harvesting technology. The pairing signal source 111 may be detachable from the remote controller 110. The pairing signal source 111 or the remote controller 110 may be removed from the wall and replaced after the pairing process is complete. The control signal source 112 may be an omnidirectional radio frequency (RF) source. In some cases, the LED light source 121 may be utilized as the sensor to receive the directional optical signal. In some other cases, a separated sensor may be used to receive the directional optical signal. The directional topical signal is modulated with the pairing information which may contain the remote controller address as the unique identifier of the remote controller. The lighting device 120 is operative to detect the signal strength of the directional optical signal and compare the signal strength with a predetermined value. If the signal strength is larger than the predetermined value, the lighting device 120 is paired with the remote controller 110. The lighting device 120 may store the remote controller address in the memory of the lighting device. The lighting device 120 may emit a visible or audible signal to confirm the pairing. For example, the light device 120 may confirm by flashing the light source 121 several times or beeping.

In some embodiments, the pairing signal source may be detachable or a separate device from the remote controller. The pairing signal source is first programmed to the remote controller by any of the standard methods. Then the pairing signal source is used to pair the lighting device and remote controller by pointing the pairing signal source at the lighting device. In some embodiments, a remote controller may be paired to one or more lighting devices for providing features like an “all off” switch at the exit of a room. In some embodiments, more than one remote controller may be paired to a lighting device.

In some embodiments, the remote controller may be of a piezoelectric or electromagnetic energy harvesting type and may be equipped with a wall mounting bracket, hook and loop such as Velcro, magnets or tape for mounting to the wall. The lighting device may be a lighting fixture that is movable and used in a DC ceiling or wall grid such as devices conforming to the EMerge Alliance Standard. The system with a hybrid control technique of directed IR pairing and omnidirectional RF control may be utilized in a reconfigurable lighting system. The system is easy to use and implement. User simply points the remote controller at the desired fixture and selects the fixture in a manner similar to controlling a television. The method is easy compared to other methods including presetting addresses, a series of button presses on the fixture and remote, proximity pairing, or using a floor plan and building automation system.

In some embodiments where LEDs are used as light sources and sensors, the bidirectionality facilitates using the lighting fixture as a signal receiver of information from a directed remote control device. If a fixture has more than one light source that is desired to be controlled separately, it is difficult to use proximity to determine which part of the fixture is to be paired. When LEDs are used as sensors, the user can point the remote controller at the desired light source (LED) to select and pair the particular light source.

This system significantly reduces user errors. The process of traditional pairing often uses a trial and error approach. In these processes, the sources of error are inputting the wrong address, being closer to the undesired fixture than the desired fixture, multiple button presses, pressing the wrong button, or pressing buttons in the wrong order. These errors are eliminated by using the directionality of the remote controller to intuitively select the fixture to pair.

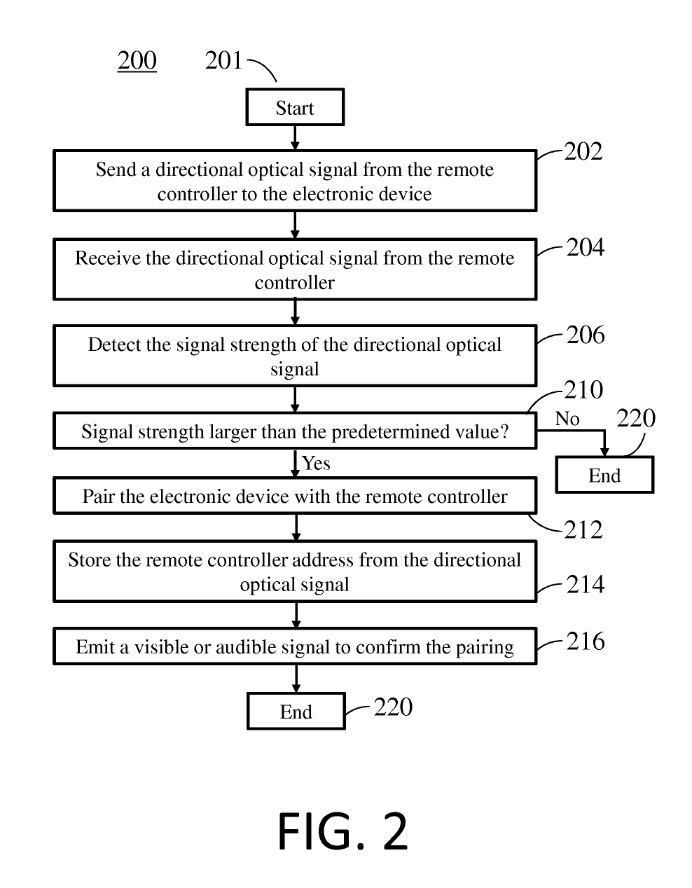

FIG. 2 shows a flow chart of an illustrative process of pairing an electronic device with a remote controller. Process 200 may begin at step 201. At step 202, the remote controller may send a directional optical signal to the electronic device. At step 204, the electronic device may receive the directional optical signal from the remote controller. At step 206, the electronic device may detect the signal strength of the directional optical signal. At step 210, the electronic device may compare the signal strength with a predetermined value and determine whether the signal strength is larger than the predetermined value. If the signal strength is not larger than the predetermined value, process 200 may move to step 220 and end the pairing process. If the signal strength is larger than the predetermined value, process 200 may move to step 212 and pair the electronic device with the remote controller. Process 200 then may move to optional step 214 to have the electronic device store the remote controller address from the directional optical signal. Process 200 then may move to optional step 216 to have the electronic device emit a visible or audible signal to confirm the pairing. In some embodiments, the optional steps may not be necessary. Process 200 may then end at step 220.

The order in which the steps of the present methods are performed is purely illustrative in nature. In fact, the steps can be performed in any order or in parallel, unless otherwise indicated by the present disclosure. The various elements of the described embodiments can be exchanged or mixed, unless otherwise indicated by the present disclosure. The invention can be embodied in other specific forms without departing from the spirit or essential characteristics thereof. The foregoing embodiments are each therefore to be considered in all respects illustrative, rather than limiting of the invention.

While the principles of the invention have been described herein, it is to be understood by those skilled in the art that this description is made only by way of example and not as a limitation as to the scope of the invention. Reference numerals corresponding to the embodiments described herein may be provided in the following claims as a means of convenient reference to the examples of the claimed subject matter shown in the drawings. It is to be understood however, that the reference numerals are not intended to limit the scope of the claims. Other embodiments are contemplated within the scope of the present invention in addition to the exemplary embodiments shown and described herein. Modifications and substitutions by one of ordinary skill in the art are considered to be within the scope of the present invention, which is not to be limited except by the recitations of the following claims.

What is claimed is:

1. A method for pairing a remote controller with an electronic device, comprising:
sending a directional optical signal from the remote controller to the electronic device;
receiving the directional optical signal from the remote controller;
detecting the signal strength of the directional optical signal;
comparing the signal strength with a predetermined value; and
pairing the remote controller with the electronic device when the signal strength is larger than the predetermined value.

2. The method of claim 1, wherein the directional optical signal comprises a remote controller address.

3. The method of claim 2, wherein the remote controller address is a unique identifier of the remote controller.

4. The method of claim 2, further comprising:
storing the remote controller address to pair the remote controller.

5. The method of claim 1, further comprising:
emitting a visible signal from the electronic device to confirm the pairing.

6. The method of claim 1, further comprising:
emitting a audible signal from the electronic device to confirm the pairing.

7. The method of claim 1, further comprising:
detaching a directional optical signal source from the remote controller.

8. A system for pairing an electronic device with a remote controller, the system comprising:
a remote controller comprising a pairing signal source operative to send a directional optical signal; and
an electronic device operative to:
receive the directional optical signal;
detect the signal strength of the directional optical signal;
compare the signal strength with a predetermined value; and
pair the remote controller with the electronic device when the signal strength is larger than the predetermined value.

9. The system of claim 8, wherein the directional optical signal comprises a remote controller address.

10. The system of claim 9, wherein the remote controller address is a unique identifier of the remote controller.

11. The system of claim 9, wherein the electronic device is further operative to:
store the remote controller address to pair the remote controller.

12. The system of claim 8, wherein the electronic device is further operative to:
emit a visible signal from the electronic device to confirm the pairing.

13. The system of claim 8, wherein the electronic device is further operative to:
emit an audible signal from the electronic device to confirm the pairing.

14. The system of claim 8, wherein the pairing signal source is detachable from the remote controller.

15. The system of claim 8, wherein the directional optical signal is a directional infrared signal, a directional visible light signal, or a directional ultraviolet signal.

16. The system of claim 8, wherein the pairing signal source is operative to send the directional optical signal having a narrow beam angle.

17. The system of claim 16, wherein the beam angle is less than 15 degrees.

18. The system of claim 16, wherein the beam angle is less than 10 degrees.

19. The system of claim 16, wherein the pairing signal source is operative to send the directional optical signal having a narrow beam angle so that a light spot of the directional optical signal on the electronic device is substantially smaller than or similar to the electronic device.

20. The system of claim 8, wherein the pairing signal source is a laser, LED, or collimated LED.

21. The system of claim 8, wherein the remote controller further comprises a control signal source being operative to send a control signal.

22. The system of claim 21, wherein the control signal comprising the remote controller address.

23. The system of claim 22, wherein the electronic device is further operative to:
receive the control signal;
compare the remote controller address from the control signal with one or more stored remote controller addresses from the directional optical signal; and
control the electronic device according to the control signal if the remote controller address from the control signal matches at least one of the stored remote controller addresses from the directional optical signal.

24. The system of claim 22, wherein the control signal source is operative to send omnidirectional radio frequency control signal.

25. The system of claim 8, wherein the electronic device is a lighting device comprising a light source.

26. The system of claim 25, wherein the light source comprises at least one LED.

27. The system of claim 25, wherein the light source is operative to receive the directional optical signal.

28. The system of claim 27, wherein the pairing signal source is operative to send the directional optical signal having a narrow beam angle so that a light spot of the directional optical signal on the electronic device is substantially smaller than or similar to the light source.

29. A system for pairing an electronic device with a remote controller, the system comprising:
a remote controller comprising a laser generator and radio frequency generator, the laser generator being operative to send an infrared pairing signal having a narrow beam angle, the infrared signal comprising a remote controller address, the radio frequency generator being operative to send radio frequency control signal, the radio frequency control signal comprising the remote controller address; and
a lighting device operative to:
receive the infrared pairing signal;
detect the signal strength of the infrared pairing signal;
compare the signal strength with a predetermined value;
pair the remote controller with the electronic device when the signal strength is larger than the predetermined value;
store the remote controller address to pair the remote controller;
receive the radio frequency control signal;
compare the remote controller address from the radio frequency control signal with one or more stored remote controller addresses from the infrared paring signal; and
control the electronic device according to the radio frequency control signal if the remote controller address from the radio frequency control signal matches at least one of the stored remote controller addresses from the infrared paring signal.
